(19) United States
(12) Patent Application Publication
(10) Pub. No.: US 2007/0299595 A1
(43) Pub. Date: Dec. 27, 2007

(54) Traffic control system and method

(76) Inventor: Anthony Boldin, Milwaukee, WI (US)

Correspondence Address: BOYLE FREDRICKSON S.C., 840 North Plankinton Avenue, MILWAUKEE, WI, 53203, US

(21) Appl. No.: 11/473,688

(22) Filed: Jun. 23, 2006

(51) Int. Cl. G08G 1/00

(52) U.S. Cl. 701/117

(57) ABSTRACT

The system and method disclosed utilize a smart metering system that combines real-time traffic data and statistical traffic models to control vehicle flow. Also disclosed are a system and method for using dual-use traffic lanes that function as regular traffic lanes under regular traffic conditions and as emergency traffic lanes in an emergency. Vehicle speed control devices can be used to prevent or break up slower traffic waves when they occur.

### BACKGROUND OF THE INVENTION

1. Field of the Invention

The present invention relates to a traffic control system and method, and more particularly, relates to a system and method that could be implemented in connection with an existing highway to improve traffic throughput.

2. Background

Traffic congestion, being defined as traffic moving at speeds less than the posted minimum speeds and having periods of slowdowns and braking, has been increasing steadily for a long time. There are great costs and losses associated with traffic congestion. For instance, fuel costs increase with regular acceleration and braking, reducing the fuel economy of any vehicle from its anticipated highway miles per gallon to “city driving” miles per gallon. This is about a 20% reduction in fuel economy, which in turn increases dependency on foreign oil supplies.

Obviously, traffic congestion causes productivity losses for delivery vehicles and employees who are spending more time on the road than at work. There is also an increased human cost from frustration and anxiety, and increased personal and societal costs from accidents resulting from unknown and unpredictable slowdowns or difficult merges.

Furthermore, environmental emissions are greater as a result of longer times spent on the road. Not only are overall engine running times longer, but vehicles are required to accelerate and decelerate multiple times rather cruise at optimum engine speeds of 55-65 mph.

Finally, traffic congestion has caused increased urban sprawl, since businesses move out of central business districts so that employees need not drive downtown to work, and employees naturally follow such that businesses and residences move further and further from the central urban areas.

Presently, the most successful attempts at improving vehicle flow and reducing traffic congestion have been accomplished by adding traffic lanes and adding traffic meters at on-ramps. Adding lanes adds capacity, while metered on-ramps prevent “clumping.” “Clumping” occurs when a group of cars enter the highway at the same time, at the same on-ramp, when the highway is nearing or has reached its capacity, i.e. when there is traffic congestion. Because there is not enough available capacity, the highway can not absorb the entering group and slowdowns and braking occur. Meters attempt to solve this problem by letting only one car at a time enter the highway at some specified interval, such as a few car lengths.

With the cost of adding lanes estimated at $10-20 million per mile at a minimum, without taking into consideration any right-of-way purchases, elevated bridges, or other alignment reconstructions, adding lanes to add capacity is an extremely expensive venture. In addition to requiring expensive construction, the solution of adding lanes takes up valuable space and is not a flexible solution.

An even more effective way to increase traffic throughput is to ensure maximum traffic speed and density on the highway. In present traffic systems, highway speeds drop below 50 mph, and in many cases down to 10 to 20 mph, causing the actual capacity of the highway to be severely limited. Even if a system is theoretically capable of moving 2200 vehicles per lane per hour past a particular point, the true capacity of the system is the maximum capacity at the worst bottleneck, thus is perhaps only moving 1000 vehicles per hour, or fewer, past a particular point. Implementing a system that keeps the highway moving at highway speeds is at least equivalent to adding lanes in terms of throughput, and perhaps better.

The key to increasing throughput is maintaining the speed of the vehicles and their density. Metering works to a degree, but cannot account for the many variables that cause traffic congestion along a specified route. To increase throughput, highway speeds should be kept over 50 mph at all times and the density should be maintained at or below a threshold point to prevent the congestion that results.

There is no traffic system currently in use that accounts for the many variables that cause inefficient traffic patterns and/or physically controls vehicle speeds to prevent unproductive waves of brake-accelerate, or stop-and-start, highway traffic. Thus, a system that solves these problems in a relatively simple and cost-effective manner is needed.

### SUMMARY OF THE INVENTION

Presently, highways typically have one or two- traffic lanes in each direction that are not being used. These lanes are called emergency lanes and are reserved for emergency use, such as when an emergency vehicle requires passage. In such a case, non-emergency vehicles can use the emergency lanes to pull over, allowing the emergency vehicle to proceed to its destination, or the emergency vehicle can use the lane to pass traffic and reach an accident scene. Vehicles with mechanical or other operating difficulties are sometimes seen in emergency lanes awaiting help.

However, most serious emergencies on the highway are accident related, and the vehicles involved generally remain in the lane or lanes in which they landed after the accident, which is not usually the emergency lane. Emergency vehicles push through traffic congestion behind the accident in any way they can, including using a combination of regular lanes and emergency lanes as needed. In addition, cars with mechanical troubles typically exit the highway completely at the next off-ramp. Emergency lanes are therefore used only a fraction of the time, an estimated >0.1% of the time they are available. Thus, a preferred embodiment of the present invention includes utilizing dual-use lanes that function as regular traffic lanes under regular traffic conditions and as emergency traffic lanes in an emergency.

In addition, the nature of rush-hour driving encourages drivers to go as fast as possible. If the posted speed is 55 or 65 mph, there are always individuals who try to go 10 or 15 mph greater than that. This is a detriment to the overall traffic system as it causes “waves” of acceleration and braking, which is the definition of traffic congestion. If drivers refrained from over-accelerating after emerging from a slow wave, they would not have to over-brake on meeting the next slow wave. However, drivers cannot be prevented from over-accelerating; the solution therefore lies in preventing slow waves from occurring. A preferred embodiment of the invention thus also employs vehicle speed control-devices to prevent or break up slower traffic waves when they occur and keep traffic moving at a steady pace.

Finally, since metering works to a certain degree, a preferred embodiment of the invention includes an advanced metering system that utilizes intelligent real-time statistics to manage incoming volume, but with a predictive aspect that accounts for statistical and/or historical traffic conditions.

### BRIEF DESCRIPTION OF THE DRAWINGS

Preferred exemplary embodiments of the invention are illustrated in the accompanying drawings, in which like reference numerals represent like parts throughout, and in which:

FIG. 1 illustrates a first embodiment of the traffic control system of the present invention;

FIG. 2 is a top view of an emergency vehicle traveling in the dual-use lane of the embodiment shown in FIG. 1;

FIG. 2a is a perspective view of proposed dual-use lane indicator of the embodiment shown in FIG. 1;

FIG. 3 is a top view of a vehicle stopped on the highway and proposed stopped vehicle sensors of the embodiment shown in FIG. 1;

FIG. 4 illustrates proposed on-ramp access gates of the smart metering system of the invention; and

FIG. 5 is a flow-chart illustrating one embodiment of the method of the present invention.

### DETAILED DESCRIPTION OF THE PREFERRED EMBODIMENTS

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

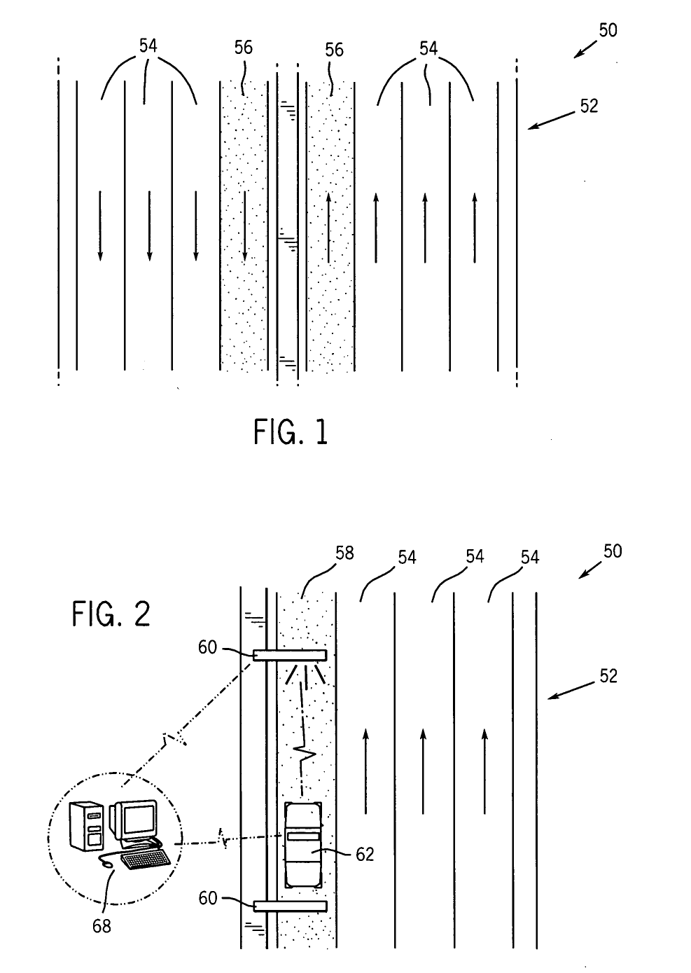

As seen in FIG. 1, a first embodiment of the traffic control system 50 of the present invention allows highway 52 with regular traffic lanes 54 and left side emergency lanes 56 to be designed for dual use. That is, left side emergency lanes 56 would have a primary function as a normal lane to add capacity to highway 52 without adding concrete, and would have a secondary function as an emergency lane on an as-needed basis. These convertible lanes will hereinafter be referred to as dual-use lanes 58.

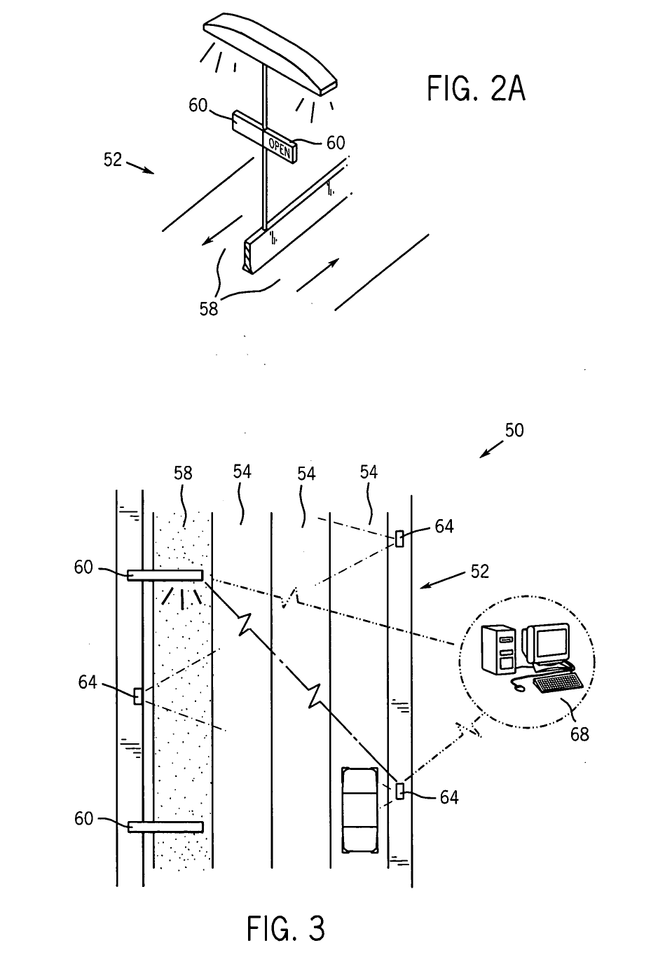

Thus, referring now to FIGS. 2 and 2a, in a preferred embodiment of the invention, dual-use lane indicators 60 are provided above or beside dual-use lanes 58 so that emergency vehicles 62, such as police cars, fire trucks, and ambulances, could activate dual-use lane indicators 60. The indicators 60 would be provided approximately every one-eighth of a mile and, in an emergency, emergency vehicles 62 would cause indicators 60 to change from a normal mode to an emergency mode. This could be done by transmission of an emergency signal directly to indicators 60, or by transmission of an emergency signal to a central processing system 68, which would in turn change indicators 60 to the emergency mode. Dual-use lane indicators 60 would be changed to an emergency mode at the location of the emergency vehicle 62 and at all locations a predetermined distance forward of the emergency vehicle 62, such that indicators 60 would be caused to display the need for use of the dual-use lane 58 as an emergency lane. Dual-use indicators 60 might display a message such as “Emergency! Lane Now Closed. Merge Right.” Indicators 60 could additionally or alternatively display a green circle when dual-use lane 58 is serving as a normal traffic lane and change to a red “X” with an arrow signal to merge right, or some other easy to understand visual device, when serving as an emergency lane. Dual-use lane indicators 60 could be of a metal and/or electronic variety, but such outdoor signs are expensive. A less expensive option may be to provide extending, banner-type signs to serve as indicators 60. Any suitable system for alerting travelers to the existence of an oncoming emergency vehicle and requesting that they vacate the dual-use lane 58 could be used, thereby turning a little-used emergency lane 56 into a useful regular travel lane 54 while at the same time allowing for emergency use.

As shown in FIG. 3, system 50 may also include stopped vehicle sensors 64, so that if a vehicle were to break down, stopped vehicle sensors 64 would be able to detect that a vehicle had not moved in a certain time frame. Stopped vehicle sensors 64 would be able to change the surrounding dual-use indicators 60 from a normal traffic lane mode to an emergency lane mode either via direct transmission of stopped vehicle information to the surrounding indicators 60 or by relay of the stopped vehicle information through central processing system 68 to indicators 60. Stopped vehicle sensors 64 would also be located approximately every one-eighth of a mile, and thus could conveniently be located within or adjunct to dual-use lane indicators 60. This functionality may not be necessary if the portion of highway 52 being monitored also had a right emergency lane available for stopped vehicles. Stopped vehicle sensors 64 would also be able to alert authorities to the presence of a stopped vehicle so that the occupants of a stopped vehicle would not have to call or wait for another driver to call.

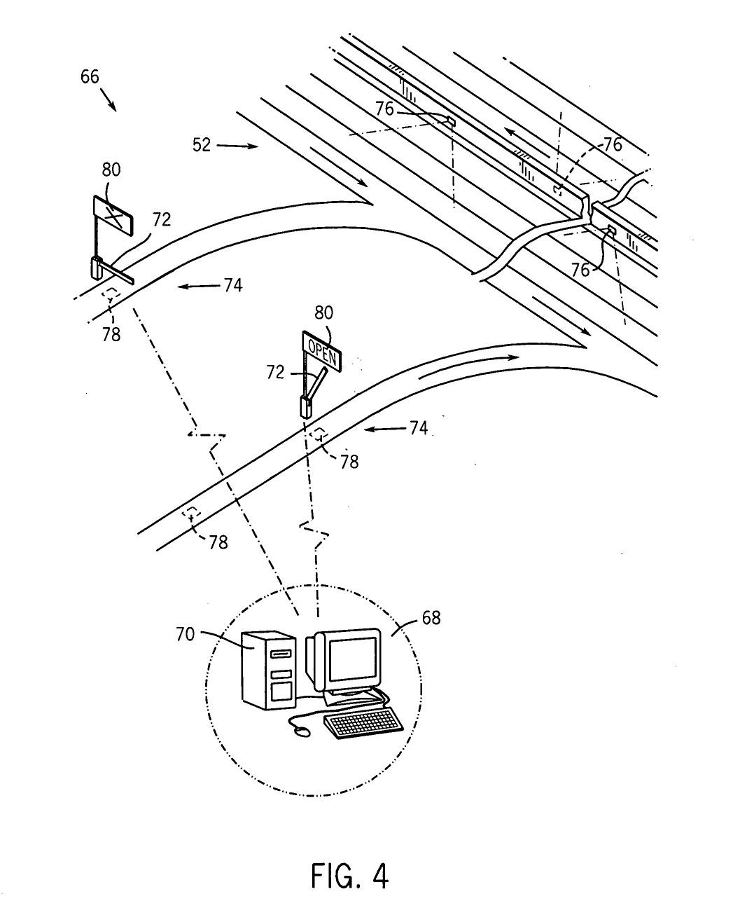

Another preferred embodiment of the traffic control system 50 employs a smart metering system 66, illustrated in FIG. 4. Preferred components of the metering system 66 include a central processing system 68 with database storage 70, on-ramp access gates 72 at each on-ramp 74 of highway 52, and traffic variable sensors 76. Each on-ramp access gate 72 additionally preferably includes a vehicle queue sensor 78 and a message board 80.

Central processing system 68 is designed to receive and store all of the information from the various sensors 64, 76, 78 of the system 50. In conjunction with data stored in database storage 70, the central processing system 68 calculates meter rates for each on-ramp 74 and controls the rate of opening of on-ramp access gates 72 accordingly.

For example, database storage 70 could include a database of historical traffic information for particular stretches of highway 52. Such historical traffic information could include traffic density at particular times of the day on particular days of the week during particular seasons or under particular circumstances, e.g. 6 pm Tuesday, Milwaukee Brewers baseball game scheduled at 7:05 pm. This data would differ from historic traffic information of different times, days, seasons, and circumstances, e.g. 4 am Tuesday, heavy snowfall.

Database storage 70 could also include a database of statistical traffic information for particular stretches of highway 52. The number of vehicles entering at particular on-ramps, the number of vehicles expected to exit at particular exits, the frequency of traffic delays between particular points of the highway 52, etc. would be included in such a database. This database could be constructed by performing a survey, perhaps on a quarterly basis, to find out the number of vehicles entering highway 52 at each on-ramp 74, and determining how many of the vehicles exit at which off-ramps. For example, of the X vehicles entering the highway at Location A, Y will exit at Location B, Z will exit at Location C, etc. The real percentages as determined by the survey can then be employed to construct calculated traffic flow models, and this data will be used to determine the allowable rate of vehicle entry at given on-ramp access gates 72. It should be noted that the manner in which data for the database is collected is not limited to any particular type of survey. Video or laser tracking, pencil-and-paper questionnaires, manual counts, or any other method could be employed, so long as the distribution of vehicles entering and exiting at different locations along highway 52 can be mapped.

Central processing system 68 would also receive information from traffic variable sensors 76 located on the highway 52 every one-quarter to one-half mile or so. Traffic variable sensors 76 could include one sensor 76 that-measures traffic variables for each lane, or one sensor 76 that measures traffic variable across a number of lanes. The sensors 76 could be located above highway 52, in highway 52, or in any other feasible location for detecting traffic variables. Traffic variable sensors 76 would measure at least two variables of traffic in each lane of highway 52: (1) the speed of vehicles and (2) the density or spacing of vehicles. There is a correlation between speed and density that relates to the amount of traffic congestion.

Smart metering system 66 thus employs a variety of data sets to calculate, model, and predict traffic on highway 52, and reacts to control access to highway 52 at each on-ramp 74 with on-ramp access gates 72. On-ramp access gates 72 are like traditional on-ramp metering gates seen at high volume on-ramps in present highway systems, but are located at all or most on-ramps 74 and are connected to central processing system 68. Each on-ramp access gate 72 may additionally comprise a vehicle queue sensor 78 and a message board 80. Vehicle queue sensors 78 measures the number of vehicles waiting to enter highway 52 at any particular on-ramp 74 and relay that information to central processing system 68 in real-time. This data is used to adjust control of access gates 72, and is also used to build a database of statistical data.

Message boards 80 may also be provided at each on-ramp access gate 72, or at least at the most frequently used gates 72, to inform waiting vehicle operators of the anticipated wait time or travel time from the on-ramp 74 to other destinations, to suggest that vehicle operators use a different route or on-ramp 74, to alert vehicle operators that the on-ramp 74 is temporarily closed, or to provide any other message that may be useful to vehicle operators at the gate 72.

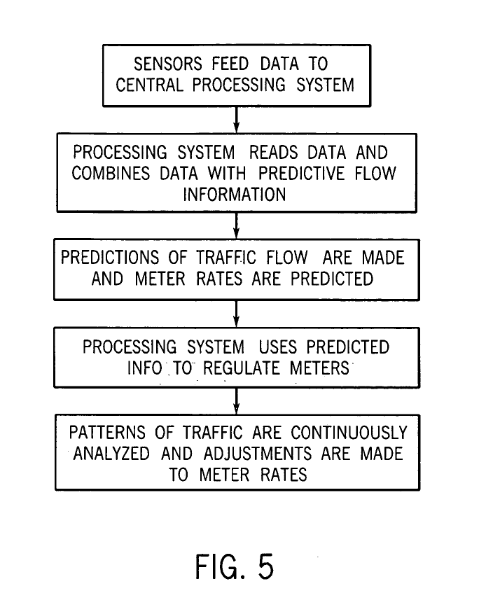

As illustrated in FIG. 5, a preferred method of using the smart metering system 66 of the present invention is as follows. Each of the sensors 76, 78 feeds traffic data to central processing system 68. Processing-system 68 takes the real-time conditions and combines them with the rates of increase or decrease from very recent conditions (i.e. within the last 5, 10, 30 minutes), the statistics from the very recent history (yesterday, the day before, last week), and also combines them with the predictive flow of upcoming incoming traffic from each of the on-ramps 74, along with where they are predicted to exit in the very near upcoming future (i.e. in the next 5, 10, 30 minutes). From all of this information, the processing system 68 calculates what the meter rates should be at each on-ramp 74 and send signals to each on-ramp access gate 72 to implement the calculated rate of entry. On an ongoing basis, the central processing system 68 also tracks its predictions and compares them against (1) actual traffic conditions as determined from sensors 76, 78 and (2) the meter rates implemented as a result of the predictions to determine if the meter rates were accurate or offset. The amount and pattern of offset are then analyzed to make adjustments to the predictive model for continuous improvement over time.

The inclusion of real-time conditions in the analysis undertaken by smart metering system 66 is especially valuable when traffic control system 50 also includes dual-use lanes 58, discussed supra. The flow of traffic will be significantly altered when a lane is taken out of commission for use as an emergency lane, and adjustments for the flow of traffic into the system will need to be made.

Smart metering system 66 may also employ a fee-based on-ramp system, not shown in the drawings. The fee-based on-ramp system would allow users who wish to pay a fee access to the highway at a different rate than non-fee-paying users. Since the smart metering system 66 will eliminate or substantially ameliorate traffic jams on the highway, it is expected that the majority of waiting in the system will be done at the on-ramps. Users will thus desire access to the highway, and some may be so desirous of accessing the highway before others that they will pay a fee to be allowed such access. The fee-paying users would then be allowed to enter the highway at a rate faster than the rate of entry of non-paying users. In addition, it is contemplated that the fee associated with a faster rate of entry would be adjustable throughout the day so that during peak traffic times, it would cost more to “skip to the front of the line” than at other times.

The fee-payment could be completed at a toll-booth located at the on-ramp, or may be electronic pass driven at the on-ramp, similar to the “I-Pass” system presently used by the Illinois State Toll Highway Authority. Adding tolls on a highway, even electronic pass driven tolls, is expensive, takes up space, causes congestion, and decreases vehicle throughput. However, adding tolls at each on-ramp is expected to cost less, takes up no highway space, frees the highway from congestion, and allows for increased vehicle throughput. The congestion ordinarily found on the highway will be relocated to the on-ramps of the system, but once access to the highway has been gained, a smooth trip is expected.

In another preferred embodiment of the system, not shown, vehicle speed control devices are used to prevent or break up slower traffic waves when they occur. These devices, also known as “wave rippers,” are preferably comprised of a series of vehicles equaling the number of lanes in the system. The vehicles are spaced laterally from one another in each lane of traffic and drive side by side one another at the precise same speed so that no other vehicles can pass. This results in the regulation of traffic speed by preventing over-acceleration to a highway speed that cannot be maintained such that over-braking will occur not far down the road. It will also facilitate slowing of traffic in a smooth and steady fashion towards any slow spots that do inadvertently occur, thus preventing the slow spots from being exacerbated. The wave rippers are sent into action when stop-start-stop-start traffic patterns or waves are detected, and the rippers act as physical barriers to vehicles in traffic to break the stop-start cycle and “smooth out” the traffic pattern. Alternatively, wave rippers could be used on a preventative basis, preventing vehicles from going above a maximum speed calculated by real-time traffic conditions. The rippers would prevent a start-stop traffic pattern from emerging by encouraging or requiring a lower, but constant, maximum speed.

Although vehicle-sized wave rippers are described, and are presently considered the best mode of this aspect of the invention, other embodiments of the wave rippers are also envisioned. For example, the wave rippers need not be vehicles or even vehicle sized. The wave rippers need not be in every lane, but could be adjacent each lane with a portion extending into the lane to physically restrain vehicles therebehind. Or, the wave rippers could be comprised of a device on one or both sides of the highway system with a portion extending across all lanes.

Although a physical barrier forming the wave ripper is presently contemplated as best preventing overzealous drivers from driving in a way that is detrimental to the overall traffic system, in the event that cost or other considerations prevent the establishment of a physical barrier, the wave ripper idea could also be implemented in the form of a device that does not actually extend into the lanes. A modified version could include lights, flags, or other indicators moving at the desired speed. These indicators could be located on one or both sides of the highway, adjacent each lane, or even overhead. Despite the fact that this version would not physically prevent individuals from making poor driving choices, it would benefit the system by instructing drivers as to the benefits of the maximum speed indicated by the wave rippers, and encourage drivers to comply. In addition, when the wave rippers indicate a very slow maximum speed, drivers will be signaled to traffic conditions ahead, including upcoming congestion. Knowledge of upcoming traffic conditions can help drivers prevent potential collisions, which are often caused by a sudden, unforeseen change in traffic conditions on the highway.

In addition to various modifications and changes that could be made without departing from the spirit of the invention, the interchangeability of various aspects of the invention should be noted. That is, not all elements need to be used at every portion of the traffic system. Rather, it is contemplated that each element could stand on its own, or be used in conjunction with one or more of the other elements, or be used in various locations across a highway system as desired by the user. All of the modification, changes, and combinations of elements are considered part of the invention, as more fully laid out in the claims, below.

I claim:

1. A traffic control system for a highway having a series of on-ramps along the length of the highway for allowing access to the highway, the system comprising:
a smart metering system that controls access to the highway at the on-ramps based on real-time traffic data and stored traffic data.

2. The traffic control system of claim 1, further comprising a plurality of vehicle speed control devices for preventing stop-and-go traffic patterns on a highway.

3. The traffic control system of claim 1, further-comprising at least one dual-use traffic lane that functions as a regular traffic lane under regular traffic conditions and as an emergency traffic lane in an emergency.

4. The traffic control system of claim 3, wherein the at least one dual-use traffic lane is converted from a regular traffic lane to an emergency traffic lane by a plurality of dual-use lane indicators placed along the length of the highway.

5. The traffic control system of claim 4, wherein the dual-use lane indicators are switched from a regular mode to an emergency mode by the presence of an activated emergency vehicle.

6. The traffic control system of claim 4, wherein the dual-use lane indicators are switched from a regular mode to an emergency mode by a central processing system that is able to receive data regarding the location of an activated emergency vehicle.

7. The traffic control system of claim 4, further comprising stopped vehicle sensors able to detect the presence of a stopped vehicle in the dual-use lane.

8. The traffic control system of claim 7, wherein the dual-use lane indicators are switched from a regular mode to an emergency mode by the presence of a stopped vehicle in the dual-use lane.

9. The traffic control system of claim 7, wherein the stopped vehicle sensors are able to alert authorities to the presence of a stopped vehicle.

10. The traffic control system of claim 1, wherein the smart metering system comprises a central processing system connected with (a) a plurality of on-ramp access gates located at the on-ramps of the highway and (b) a plurality of traffic variable sensors along the length of the highway.

11. The traffic control system of claim 10, wherein the central processing system controls the rate of opening of the on-ramp access gates to achieve the maximum vehicle density allowed while maintaining maximum vehicle throughput.

12. The traffic control system of claim 11, wherein the central processing system collects and processes traffic data collected by the traffic variable sensors, and controls the rate of opening of the on-ramp access gates based in part on data collected by the traffic variable sensors.

13. The traffic control system of claim 11, wherein the central processing system includes database storage containing stored traffic data, and controls the rate of opening of the on-ramp access gates based in part on the stored traffic data.

14. The traffic control system of claim 13, wherein the stored traffic data comprises historic traffic data.

15. The traffic control system of claim 12, wherein the stored traffic data comprises statistical traffic models.

16. The traffic control system of claim 15, wherein the statistical traffic models include data comprising the distribution of exits to be used by vehicles from each on-ramp.

17. The traffic control system of claim 10, wherein the on-ramp access gates further comprise at least one vehicle queue sensor for sensing how many vehicles are waiting at the on-ramp access gate.

18. The traffic control system of claim 17, wherein the central processing system controls the rate of opening of the on-ramp access gates based in part on the data collected by the vehicle queue sensors.

19. The traffic control system of claim 11, wherein a fee-based rate for on-ramp gate opening and a free rate for on-ramp gate opening are established, and the central processing system controls the rate of opening for each to achieve the maximum vehicle density allowed while maintaining maximum vehicle throughput.

20. The traffic control system of claim 10, wherein the on-ramp access gates further comprise a message board.

21. The traffic control system of claim 10, wherein the traffic variable sensors detect traffic data and deliver the data to the central processing system in real-time.

22. The traffic control system of claim 11, wherein the central processing system improves the rate of opening of the gates by analyzing prior rates against actual prior vehicle throughput.

23. The traffic control system of claim 1, further comprising a plurality of vehicle speed control devices.

24. The traffic control system of claim 23, wherein the plurality of vehicle speed control devices comprise a series of laterally spaced vehicles.

25. The traffic control system of claim 23, wherein the plurality of vehicle speed control devices comprise a series of indicators.

26. The traffic control system of claim 23, wherein the plurality of vehicle speed control devices are employed when stop-and-start traffic patterns are detected.

27. The traffic control system of claim 23, wherein the plurality of vehicle speed control devices prevent vehicles from going above a maximum calculated speed.

28. The traffic control system of claim 25, wherein the indicators are lights.

29. A method of controlling traffic on a highway comprising the steps of obtaining real-time traffic data, analyzing real-time traffic data in light of historic traffic data, and controlling access to the highway based on the analysis.

30. The method of claim 29, wherein the step of controlling access to the highway includes use of meters at on-ramps of the highway.

31. The method of claim 29, further comprising the step of controlling vehicle density on a highway by controlling vehicle pace.

32. The method of claim 29, further comprising the step of using the highway emergency lane as a dual-use lane such that the dual-use lane is used as a regular traffic lane unless an emergency takes place.

33. The method of claim 32, wherein the step of converting the dual-use lane from a regular traffic lane to an emergency lane is accomplished by signaling vehicle drivers to exit the dual-use lane when an emergency takes place.
